(19) United States
(12) Patent Application Publication
(10) Pub. No.: US 2008/0287299 A1
(43) Pub. Date: Nov. 20, 2008

(54) Use of Imidazole and/or Triazole Derivatives for Combating Plant Pests; as Well as Method for Controlling Diseases/Insects/Mites/Nematodes and Weeds, Particularly Foliar and/or Soil Diseases

(76) Inventor: Jose Geraldo Martins Dos Santos, Sao Paulo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/908,429

(22) PCT Filed: Mar. 16, 2006
(86) PCT No.: PCT/BR06/00047

§ 371 Date: Jul. 1, 2008

(30) Foreign Application Priority Data
Mar. 16, 2005 (BR) PI0501146-9

(51) Int. Cl. A01N 43/653

(52) U.S. Cl. 504/272; 514/383

(57) ABSTRACT

The present invention relates to the use of specific imidazole and/or triazole derivatives for combating pests on plants and/or crops, and/or for preparing a fungicide/insecticide/herbicide/nematicide useful in the treatment of seeds, foliar and/or soil diseases against attacks of pests in plants. A further objective of the present invention is to provide methods of applying said imidazole and/or triazole derivatives in the control of diseases/insects/mites/nematodes and weeds, particularly foliar and/or soil diseases.

### FIELD OF THE INVENTION

The present invention relates to the use of imidazole and/or triazole derivatives for controlling fungus diseases and combating pests and weeds in the agricultural environment, and/or for preparing a fungicide/insecticide/herbicide/nematicide useful in the treatment of seeds, foliar and/or soil diseases against attacks of pests in plants.

Damages caused by diseases, pests and weeds to crops, particularly in Brazil, have been generating great losses, proportional to the amount of capital spend in combating them, particularly in view of the increase in plantation areas and the expansion of agriculture in Brazil. Besides, the group of agrochemically effective control agents for combating diseases/pathogens on plants and/or seeds is becoming more and more restrict.

To give an idea of the magnitude of the losses caused by diseases affecting crops, the so-called “soybean rust”, caused by the fungus Phakopsora pachyrhizi, has caused great damages to the soybean business. In the latest harvest the values reached the amount around US$ 3 billion, including the expenditure with fungicides for controlling it.

### PRIOR ART

The utilization of antifungal agents in agriculture, with pharmaceutical directions for use, indicated for human use, is not novel. Many triazoles were initially discovered and patented for use in antifungal treatment in humans. Later, one realized the importance of this group in controlling diseases of plants, especially cereals, horticulture and fruit growing.

Application BR 0307334-3 describes the use of alkoxylated amines for enhancing the activity of fungicidal formulations containing triazoles, and also of formulations containing one or more fungicidal triazoles and alcokxylated amines. These formulations are useful for protecting any living or non-living material such as crops, plants, fruits, seeds, objects made of wood, roofs or the like, biodegradable and textile materials, from deterioration due to the action of fungi.

Document WO 91/01640 describes combined compositions for combating pests on plants, animals and sanitary compositions, for use in forests, horticulture and silos. These compositions contain a pyrethrum-type insecticide with an active insecticidal ingredient and at least one fungicidal ingredient that inhibits the biosynthesis of ergosterol, as an active enhancing agent, as well as, optionally, piperonylbutoxide and other actives.

Document WO 2004/089396 describes compounds including peptides and peptidomimetics having antifungal activity alone and in combination with other agents that exhibit antifungal activity.

Document WO 2003/051116 discloses a microencapsulated insecticide that is prepared by oil-in-water interfacial polymerization, said insecticide being solid at room temperature and pressure and having limited solubility ion organic solvents. Various release systems for dispensing the microencapsulated insecticide to a field animal are also described. A preferred release system is an organic dispersion of the microencapsulated insecticide, an oil-in-water emulsion being prepared by emulsifying the product of the oil-in-water interfacial polymerization method to a continuous organic phase.

Document WO 01/95723 discloses parasiticidal compositions comprising an imidazole and/or triazole and a physiologically acceptable carrier, the imidazole being selected from one or more groups consisting of clotrimazole, ketoconazole and miconazole, and the triazole being selected from one or more groups consisting of fluconazole and itraconazole.

Document WO 03/007878 discloses sordarin derivatives prepared from C-11-hydroxysordarin as antifungal agents useful in the treatment and/or prevention of infections in humans and animals, as well as in controlling phytopathogenic fungus in plantations.

Document WO 03/051889 disclose novel solidarin derivatives isolated from fungus culture. The compound is useful ion the treatment and/or prevention of infections in humans and animals, as well as in controlling phytopathogenic fungus in plantations. Two new culture of fungus, ATCC No. PTA-3862 and ATCC No. PTA-3861 may be employed to ferment and produce the compound disclosed in this document.

Although various methodologies and compositions have been disclosed for the use of imidazole and/or triazole derivatives for fungicidal/insecticidal/herbicidal/nematicidal control in mammals and even in determined agricultural cultivations, there is still the need to create more effective means in the area of agrochemical agents for combating pests on plants.

Therefore, one of the objectives of the present invention is to provide the use of specific imidazole and/or triazole derivatives for combating pests on plants and/or cultures thereof and/or for preparing a fungicide/insecticide/herbicide/nematicide useful in the treatment of seeds, foliar and/or soil diseases against attacks of pests in plants.

Another objective of the present invention is to provide methods of applying said imidazole and/or triazole derivatives in the control of diseases/insects/mites/nematodes and weeds, particularly foliar and/or soil diseases.

### DETAILED DESCRIPTION OF THE INVENTION

The present invention discloses the use of specific imidazole and/or triazole derivatives, selected from the group consisting of:

(i) cis-1-acetyl-4-(4-((2-(2,4-dichloro-phenyl)-2-(1H-imidazol-1-ylmethyl)-1,3-dioxolan-4-yl)methoxyl)phenyl)piperazine, namely ketoconazole, of the structural formula:

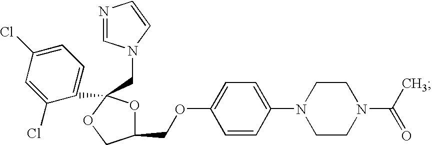

(ii) alpha-(2,4-difluorophenyl)-alpha-(1H-1,2,4-trizole-1-ylmethyl)-1H-1,2,4-trizole-1-ethanol, namely fluconazole, of structural formula

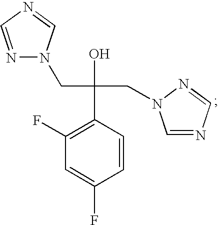

(iii) 4-[4-[4-[4-[[2-(2,4-dichlorophenyl)-2-(1H-1,2,4-triazol-1-ylmethyl)-1,3-dioxolan-4-yl]methoxy]phenyl]-1-pipera-zinyl]phenyl]-2,4-dihydro-2-(1-methylpropyl) 3H-1,2,4-triazol-3-one, namely, itraconazole, of structural formula:

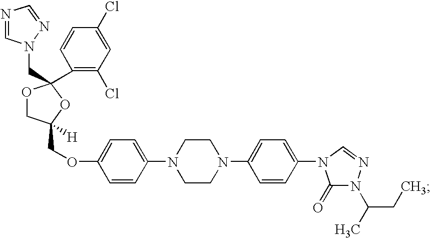

(iv) 4-[2-[(1R,2R)-2-(2,4-difluor-phenyl)-2-hydroxy-1-methyl-3-(1H-1,2,4-triazol-1-yl)propyl]4-thiazolyl]-benzonitriyl, namely, ravuconazole, of structural formula

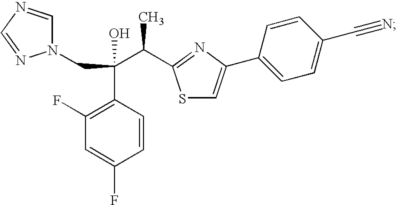

(v) alpha-(2,4-difluorophenyll)-5-fluor-beta-methyl-alpha-(1H-1,2,4-triazol-1-yllmethyl)-(R—(R*,S*))-4-pirimidinetanole, namely voriconazole of structural formula

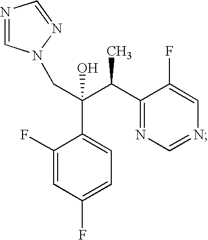

(vi) 1-((1S,2S)-1-ethyl-2-hydroxypropyl)-4-{4-[4-(4-{[(5S,3R)-5-(2,4-difluorophenyl)-5-(1,2,4-triazolylmethyll)oxolan-3-yl]methoxy}phenyl)pipera-zinyl]phenyl}-1,2,4-triazolin-5-one, namely, posaconazole, of structural formula

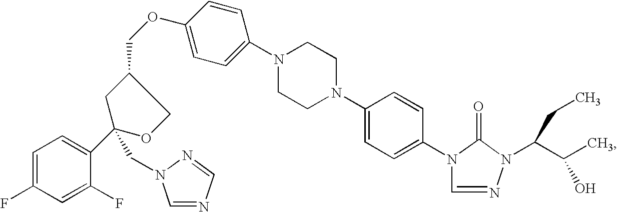

and/or mixtures thereof, for treating seeds, foliar and/or soil diseases against attacks of pests in plants, as well as for preparing fungicides/insecticides/herbicides/nematicides useful in the treatment of seeds, foliar and/or soil diseases against attacks of pests in plants.

The use of fluconazole is particularly preferred.

The active compounds ketoconazole, fluconazole, itraconazole, voriconazole, ravuconazole and posaconazole, applied either in isolation of in mixture with each other, have a broad spectrum of action as antifungal agents and are also effective for phytopathogenic fungi; particularly for those that belong to the classes of: Deuteromicetos (Botrytis spp, septoria spp, Pyricularia spp, Stagnospora spp, Hetminthosporum spp, Fusarium spp, Cerospora spp, Rhynchosporium spp, Alternaria spp, Colletotrichum spp and Isariopsis spp); Basidioomicetos (Phakopsora spp, Puccinia spp, Rhizoctonia spp, U-romyces spp and Hemileia spp); Ascomicetos (Venturia spp, Ppdosphaera spp, Erysiphe spp, Monilinia spp and Uncinula spp); Oomicetos (Phytophthora spp, Peronospora spp, Bremia spp, Pythium spp and Plasmopara spp), Sclerotina spp, Alternaria spp, Drechslera spp, Penicilium spp e Apsergillus spp, Collectotrichum spp, Phomopsis spp, Pestalotia sp and Ramularia spp.

These compounds exhibit healing, preventive and eradicative properties for protecting plants, and may be used for inhibiting or destructing infections caused in an isolated way or concomitantly by fungi on plants or parts thereof (flowers, fruits, tubercles or roots) of different crops. They may also be used for treating plant-propagation material, specially seeds, fruits, tubercles and grains with a view to protect them against soil fungi. Particularly the compositions of the present invention are effective against the attack by Phakopsora pachyrhizi, Pyricularia ssp, Helminthosporium spp, Fusarium ssp, Septoria spp, Cercospora ssp, Rhynchosporium spp, Collectotrichum spp, Pythium spp, Phomopsis spp, Phytophthora spp, Peronospora spp, Pestalotia spp, Sclerotina spp, Alternaria spp, Drechslera spp, Penicilium spp, Apsergillus spp or Ramularia spp.

Based on the spectrum of activity, the active compounds of the present invention may be used for protecting or eradicating phytopathogenic fungi, which affect various crops. The species of crops that can be embraced by the scope of protection of the present invention may be selected from: cereals (wheat, rye, oats, barley, rice, transgenic rice, mutagenic rice and sorghum); fruits (apple, pear, peach, strawberry, mulberry, citrus, mango, papaya, banana, grape); leguminous plants (beans, transgenic beans, soybeans, peas, transgenic soybeans); oleaginous plants (canola, sunflower, coconut), cucurbitaceous (cucumber, pumpkin, melon and water-melon); fibrous plants (cotton, transgenic cotton and jute); vegetables (lettuce, cabbage, spinach, carrot, asparagus, onion, garlic, tomato, potato) or plants such as corn, transgenic corn, tobacco, coffee, sugar-cane, tea, rubber tree, eucalyptus, pinus, as well as ornamental plants (flowers). Particularly, crops of wheat, soybean, rice, cotton and potato are preferred. However, this list does not constitute any limit for the non-mentioned species, especially as far as the spectrum of activity of the active cited compounds is concerned.

The method of controlling diseases/insects/mites/nematodes and weeds, particularly foliar diseases and/or soil diseases, according to the pre-sent invention, comprise the preventive and/or healing treatment and/or the application of effective amounts of said imidazole and/or triazole derivatives to the place (crop of target) to be protected and/or to the insect of pest itself. The ranges employed vary according to the crop. For the treatment of seeds, one recommends from 5 to 500 grams of the active compound(s) for 100 kg of seed. For foliar treatment, each crop requires a specific dose of the active compound(s), generally from 20 to 500 grams of the active compound(s) per hectare. For use in the soil, the amount may range from 100 to 500 grams of active compound(s) per hectare.

The illustrative examples given hereinafter will serve for describing the invention in a better way. However, the formulations described herein merely refer to some embodiments of the present invention and do should not be taken as being limitative of the scope of the invention.

### EXAMPLE 1

Recent tests carried out in greenhouses the laboratory of FMC Quimica do Brasil Ltda. in Uberaba, MG, Brazil, show the highly fungicidal effect of said specific imidazole and/or triazole derivatives in combating diseases of plants, particularly against the attack by the fungus Phakopsora pachyrhizi on soybeans, as described hereinafter.

### i) Active Compound: Ketoconazole

### Materials and Methods

Crop: soybeans

Experimental Outline: entirely made with five repetitions, two plants per repetition, totaling 10 plants

Time of Application of the Active Compound:

a) Preventive Mode: 40 days after plantation of the soybeans in plastic 2-liter pots and with corresponding volumes of soil, the soybean plants were at the V6 stage with seven expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing Mode: 40 days after plantation of the soybeans in 2-liter plastic pots and with a corresponding volume of soil, the soybean plants were at the V6 stage with seven expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-litre capacity.

Dosages: 200 to 500 grams per hectare of the active compound ketoconazole per liter diluted in water.

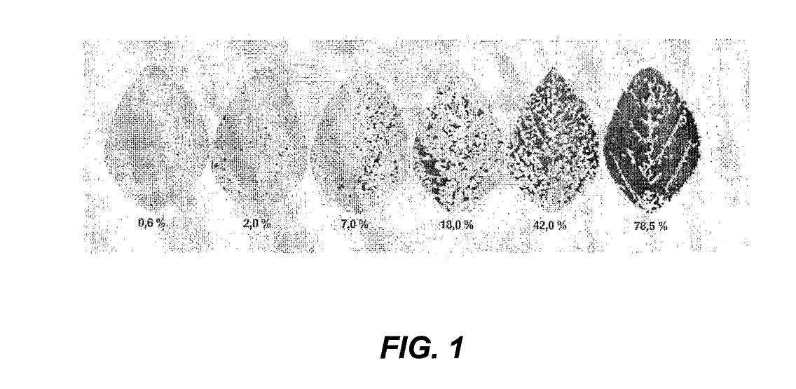

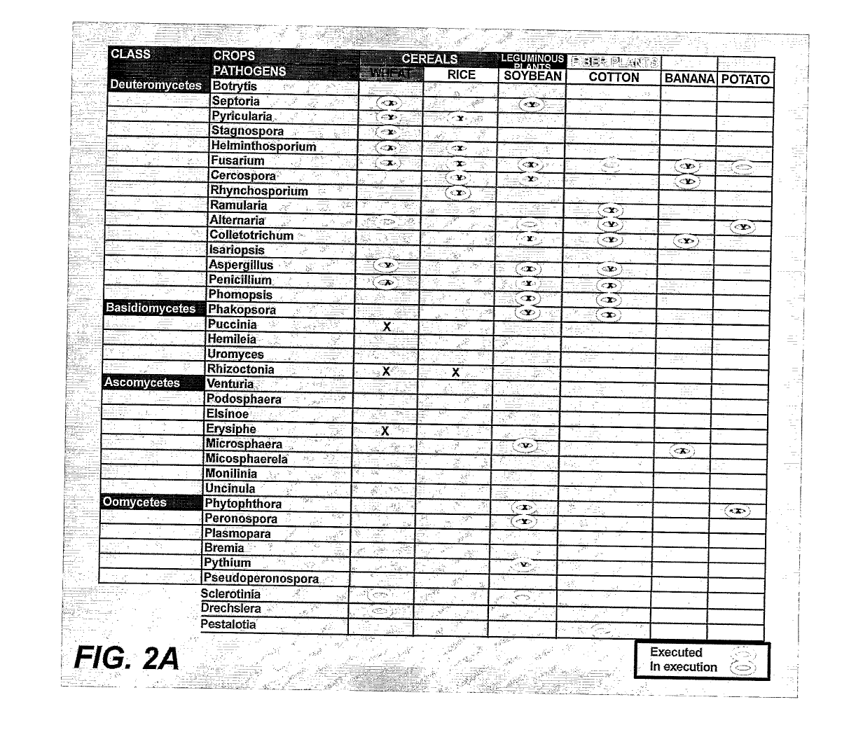

Evaluation of the Effectiveness of the Product: The evaluations were made every 5 days after application of the product, in a total of 4 evaluations. As an evaluation parameter, one has utilized the severity of the disease (percentage of the foliar area attacked by the rust) according to the Diagrammatic Scale for Evaluation of Severity of Soybean Rust—Embrapa, Centro Nacional de Pesquisa de Soja (CNPSo) (=National Center for Soybean Research), in Londrina, PR, Brazil (FIG. 1).

TABLE 1
Response of Doses of Ketoconazole for Control of the “Soybean Rust”

| | DOSAGES | SEVERITY OF RUST (% IFA**) | | | |
|---|---|---|---|---|---|
| TREATMENT | (g ac/ha) | 5 DAT* | 10 DAT | 5 DAT | 20 DAT |
| Ketoconazole | 100 | 15 | 20 | 27 | 45 |
| ketoconazole | 200 | 5 | 8 | 10 | 18 |
| ketoconazole | 300 | 3 | 6 | 10 | 16 |
| ketoconazole | 400 | 3 | 7 | 11 | 15 |
| ketoconazole | 500 | 2 | 4 | 8 | 11 |
| Blank | — | 33 | 49 | 67 | 79 |

*DAT = Days after treatment
**IFA = Infected foliar area

Ketoconazole, from the dose of 200 grams of active ingredients per hectare (Table 1), imparts effectiveness for controlling soybean rust and exhibited potential to be used as an alternative in controlling soybean rust.

### ii) Active Compound: Fluconazole

### Materials and Methods

### Crop: Soybean

Experimental Outline: entirely made with five repetitions, two plants per repetition, totaling 10 plants.

Time of Application of the Active Compound:

a) Preventive Mode: 40 days after plantation of the soybeans in plastic 2-liter pots and with corresponding volumes of soil, the soybean plants were at the V6 stage with seven expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing mode: 40 days after plantation of the soybeans in 2 liter plastic pots and with a corresponding volume of soil, the soybean plants were at the V6 stage with seven expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-liter capacity.

Dosages: 50 to 500 grams per hectare of the active compound Fluconazole per liter diluted in water.

Evaluations of the Effectiveness of the Product: The evaluations were made every 5 days after application of the product, in a total of 4 evaluations. As an evaluation parameter one utilized the severity of the disease (percentage of foliar area attacked by rust) according to the diagrammatic scale of the EMBRAPA (FIG. 1).

### Results

TABLE 2
Response of Doses of Fluconazole for Control of Soybean Rust

| | DOSES | SEVERITY OF RUST (% IFA**) | | | |
|---|---|---|---|---|---|
| TREATMENTS | (g ac/ha) | 5 DAT* | 10 DAT | 15 DAT | 20 DAT |
| Fluconazole | 50 | 5 | 10 | 12 | 12 |
| Fluconazole | 100 | 5 | 7 | 10 | 11 |
| Fluconazole | 150 | 4 | 6 | 9 | 10 |
| Fluconazole | 250 | 3 | 7 | 11 | 10 |
| Fluconazole | 500 | 0 | 0 | 2 | 4 |
| Blank | — | 34 | 48 | 88 | 75 |

*DAT = Days after treatment
**IFA = Infected foliar area

Fluconazole, from 50 grams of active ingredients per hectare (Table 2) proved to be effective in controlling soybean rust and exhibited potential for use as a fungicide in controlling this disease.

iii) Active Compound: Itraconazole

### Materials and Methods

Crop: soybean

Experimental Outline: entirely made with five repetitions, two plants per repetition, totaling 10 plants.

Time of Application of the Active Compound:

a) Preventive Mode: 40 days after plantation of the soybeans in plastic 2-liter pots and with corresponding volumes of soil, the soybean plants were at the V6 stage with seven expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing mode: 40 days after plantation of the soybeans in 2-liter plastic pots and with a corresponding volume of soil, the soybean plants were at the V6 stage with seven expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-liter capacity.

Dosages: 50 to 500 grams per hectare of the active compound Itraconazole per liter diluted in water.

Evaluations of the Effectiveness of the Product: The evaluations were made every 5 days after application of the product, in a total of 4 evaluations. As an evaluation parameter one utilized the severity of the disease (percentage of foliar area attacked by rust) according to the diagrammatic scale of the EMBRAPA (FIG. 1).

### Results

TABLE 3
Response of Doses of Itraconazole for Control of Soybean Rust

| | DOSES | SEVERITY OF RUST (% IFA**) | | | |
|---|---|---|---|---|---|
| TREATMENTS | (g ac/ha) | 5 DAT* | 10 DAT | 15 DAT | 10 DAT |
| Itraconazole | 50 | 6 | 10 | 11 | 12 |
| Itraconazole | 100 | 5 | 8 | 10 | 13 |
| Itraconazole | 150 | 5 | 8 | 10 | 13 |
| itraconazole | 250 | 3 | 5 | 10 | 14 |
| itraconazole | 500 | 0 | 2 | 0 | 10 |
| Blank | — | 29 | 51 | 54 | 75 |

*DAT = Days after treatment
**IFA = Infected foliar area

Itraconazole, from 50 grams of active ingredient per hectare (Table 3) proved to be effective in controlling soybean rust and exhibited potential for use as a fungicide in controlling this disease.

### iv) Active Compound: Ravuconazole

### Materials and Methods

### Crop: Soybean

Experimental Outline Experimental Outline: entirely made with five repetitions, two plants per repetition, totaling 10 plants.

### Time of Application of the Active Compound:

a) Preventive Mode: 30 days after plantation of the soybeans in plastic 2-liter pots and with corresponding volumes of soil, the soybean plants were at the V5 stage with six expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing mode: 30 days after plantation of the soybeans in 2-liter plastic pots and with a corresponding volume of soil, the soybean plants were at the V5 stage with six expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-liter capacity.

Dosages: 50 to 300 grams per hectare of the active compound Itraconazole per liter diluted in water.

Evaluations of the Effectiveness of the Product: The evaluations were made every 7 days after application of the product, in a total of 4 evaluations. As an evaluation parameter one utilized the severity of the disease (percentage of foliar area attacked by rust) according to FIG. 1).

### Results

TABLE 4
Response of Doses of Ravuconazole for Control of Soybean Rust

| | DOSES | SEVERITY OF RUST (% IFA**) | | | |
|---|---|---|---|---|---|
| TREATMENTS | (g ca/ha) | 7 DAT* | 14 DAT | 21 DAT | 28 DAT |
| Ravuconazole | 50 | 15 | 16 | 16 | 18 |
| Ravuconazole | 100 | 12 | 12 | 14 | 18 |
| Ravuconazole | 150 | 9 | 11 | 11 | 16 |
| Ravuconazole | 200 | 3 | 7 | 11 | 15 |
| Ravuconazole | 300 | 2 | 3 | 9 | 11 |
| Blank | — | 36 | 48 | 59 | 69 |

*DAT = Days after treatment
**IFA = Infected foliar area

Ravuconazole, from 50 grams of active ingredient per hectare (Table 4) proved to be effective ion controlling soybean rust and exhibited potential for use as a fungicide in controlling this disease.

### v) Active Compound: Voriconazole

### Materials and Methods

### Crop: Soybean

Experimental Outline Experimental Outline: entirely made with five repetitions, two plants per repetition, totaling 10 plants.

### Time of Application of the Active Compound:

a) Preventive Mode: 30 days after plantation of the soybeans in plastic 2-liter pots and with corresponding volumes of soil, the soybean plants were at the V5 stage with six expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing mode: 30 days after plantation of the soybeans in 2-liter plastic pots and with a corresponding volume of soil, the soybean plants were at the V5 stage with six expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-liter capacity.

Dosages: 50 to 300 grams per hectare of the active compound Itraconazole per liter diluted in water.

Evaluations of the Effectiveness of the Product: The evaluations were made every 7 days after application of the product, in a total of 4 evaluations. As an evaluation parameter one utilized the severity of the disease (percentage of foliar area attacked by rust) according to FIG. 1).

### Results

TABLE 5
Response of Doses of Voriconazole for Control of Soybean Rust

| | DOSES | SEVERITY OF RUST (% IFA**) | | | |
|---|---|---|---|---|---|
| TREATMENTS | (g ac/ha) | 7 DAT* | 14 DAT | 21 DAT | 28 DAT |
| Voriconazole | 50 | 8 | 10 | 10 | 13 |
| Voriconazole | 100 | 8 | 8 | 11 | 18 |
| Voriconazole | 150 | 8 | 8 | 10 | 18 |
| Voriconazole | 200 | 4 | 7 | 11 | 11 |
| Voriconazole | 300 | 2 | 0 | 1 | 5 |
| Blank | — | 33 | 50 | 68 | 74 |

*DAT = Days after treatment
**IFA = Infected foliar area

Voriconazole, from 50 grams of active ingredient per hectare (Table 5) proved to be effective in controlling soybean rust and exhibited potential for use as a fungicide in controlling this disease.

### v) Active Compound: Voriconazole

### Materials and Methods

### Crop: Soybean

Experimental Outline Experimental Outline: entirely made with five repetitions, two plants per repetition, totaling 10 plants.

### Time of Application of the Active Compound:

a) Preventive Mode: 30 days after plantation of the soybeans in plastic 2-liter pots and with corresponding volumes of soil, the soybean plants were at the V5 stage with six expanded folioles. At this moment, the compounds were sprayed and then, 48 hours afterwards, inoculation of the rust was effected. To effect the inoculation, one prepared a suspension of Phakopsora uredospores at the concentration of 2×10⁴ spores/milliliters.

b) Healing mode: 30 days after plantation of the soybeans in 2-liter plastic pots and with a corresponding volume of soil, the soybean plants were at the V5 stage with six expanded folioles. At this moment, one effected the inoculation of the rust and then, 48 hours afterwards, the compounds were sprayed. To effect the inoculation, one prepared a suspension of Phakopsora uredospores at the concentration of 2×10⁴ spores/milliliters.

Equipment: a manual sprayer commonly used in agriculture with 2-liter capacity.

Dosages: 50 to 300 grams per hectare of the active compound Voriconazole per liter diluted in water.

Evaluations of the Effectiveness of the Product: The evaluations were made every 7 days after application of the product, in a total of 4 evaluations. As an evaluation parameter one utilized the severity of the disease (percentage of foliar area attacked by rust) according to FIG. 1).

### Results

TABLE 6
Response of Doses of Posaconazole for Control of Soybean Rust

| | DOSES | SEVERITY OF RUST (% IFA**) | | | |
|---|---|---|---|---|---|
| TREATMENTS | (g ac/ha) | 7 DAT* | 14 DAT | 21 DAT | 28 DAT |
| Posaconazole | 50 | 11 | 13 | 15 | 14 |
| Posaconazole | 100 | 5 | 8 | 12 | 13 |
| Posaconazole | 150 | 0 | 6 | 9 | 12 |
| Posaconazole | 200 | 3 | 0 | 6 | 9 |
| Posaconazole | 300 | 0 | 0 | 3 | 7 |
| Blank | — | 16 | 54 | 64 | 75 |

*DAT = Days after treatment
**IFA = Infected foliar area

Pozaconazole, from 50 grams of active ingredient per hectare (Table 6) proved to be effective in controlling soybean rust and exhibited potential for use as a fungicide in controlling this disease.

### EXAMPLE 2

The following tests aim at testing the efficiency of compounds Ketoconazole (indicated as compound FF-4800), Fluconazole (indicated as compound FF-4900) and Itraconazole (indicated as compound FF-4901) against pests selected from Phakopsora pachyrhizi, Pyricularia ssp, Helminthosporium spp, Fusarium ssp, Septoria spp, Cercospora ssp, Rhynchosporium spp, Collectotrichum spp, Pythium spp, Phomopsis spp, Phytophthora spp, Peronospora spp, Pestalotia spp, Sclerotina spp, Alternaria spp, Drechslera spp, Penicilium spp, Apsergillus spp and Ramularia spp in crops of wheat, soybean, rice, cotton and potato.

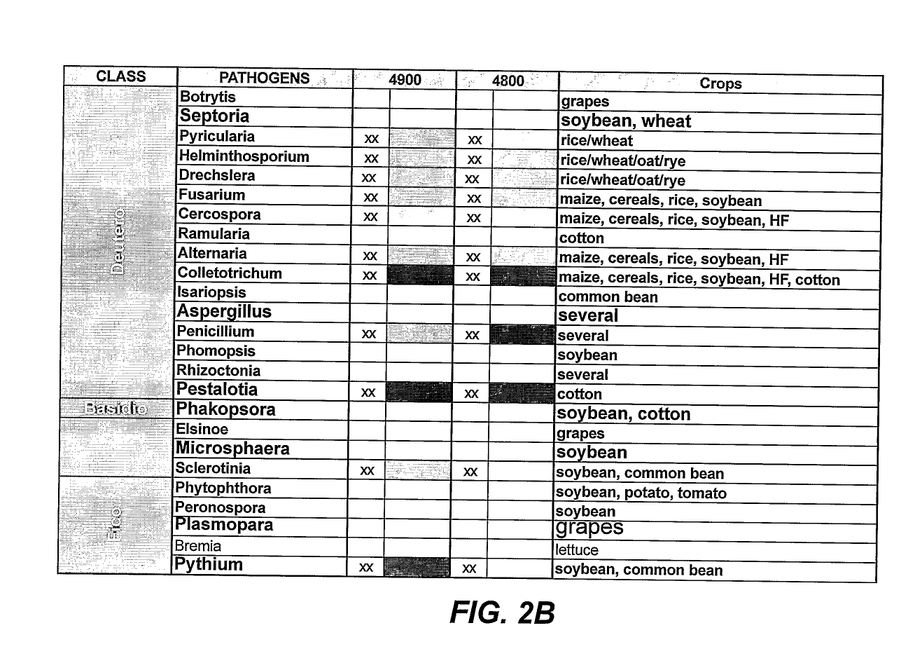

Objectives (see FIGS. 2A and 2B)

Test in vitro—1^{st} step;

Tests in vitro with defined crops—2^{nd} step;

To optimize tests in vivo:
(i) tests in greenhouse;
(ii) stability of formulations in planta;
(iii) phytotoxicity tests of formulations;
(iv) potentiality tests for TS.

### Methodology

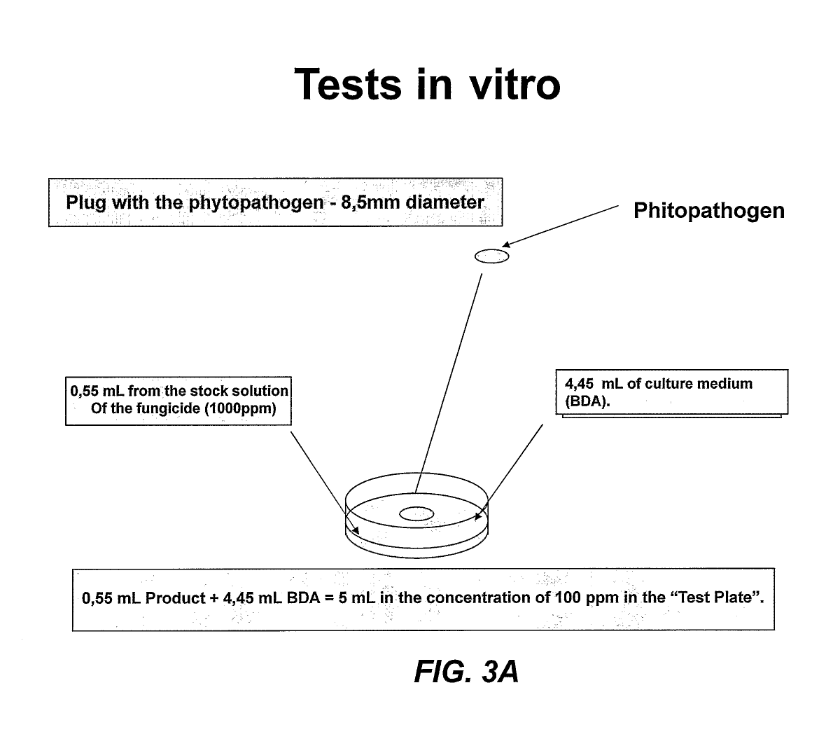

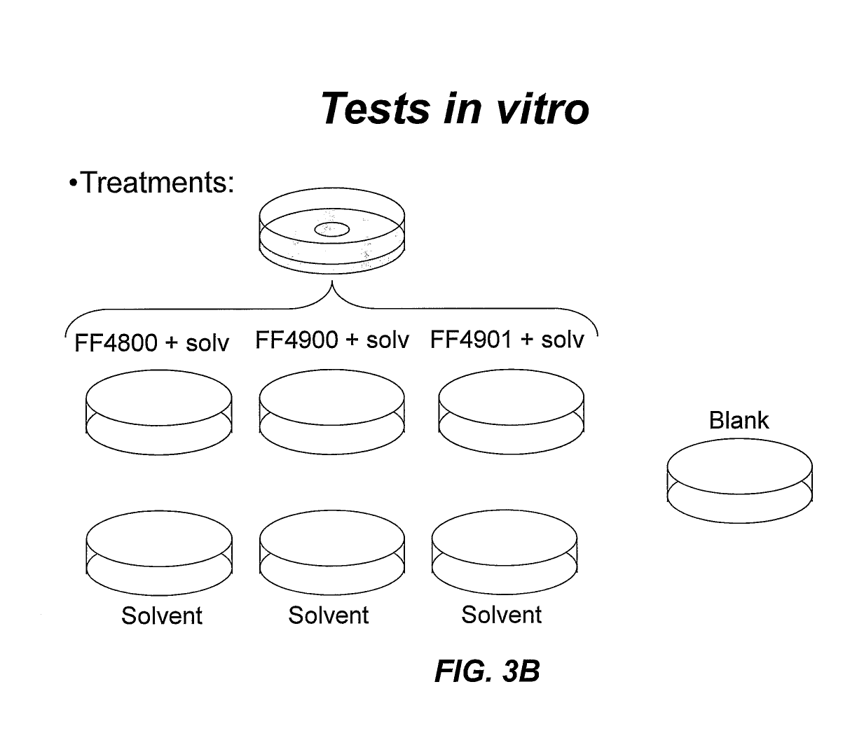

Tests in vitro in laboratory (see FIGS. 3A and 3B):

Preparing the solution:
Dissolution;
Dillution.

Culturing the phytyopathogens (BDA)

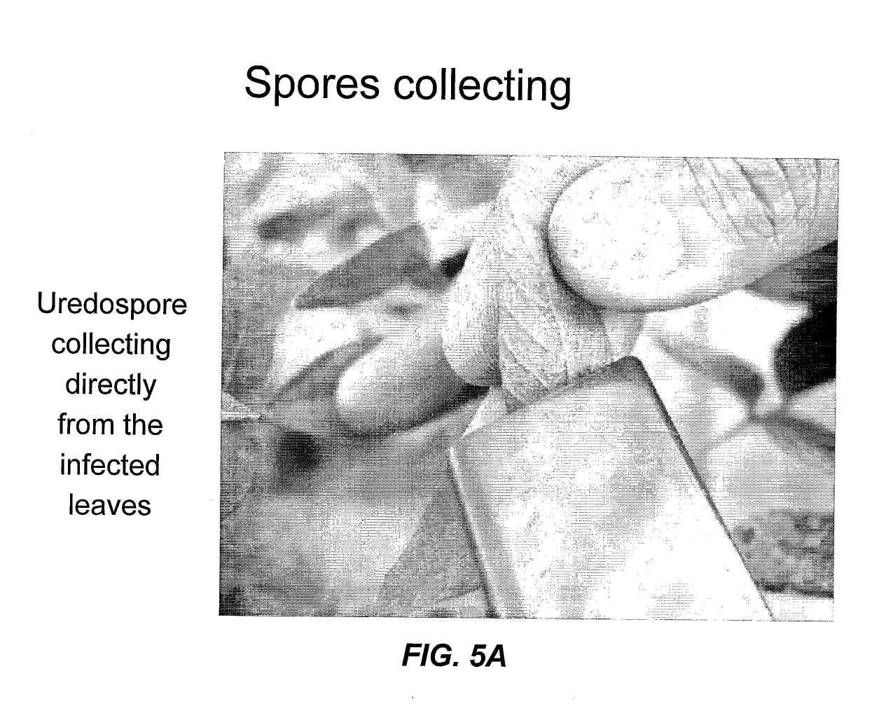

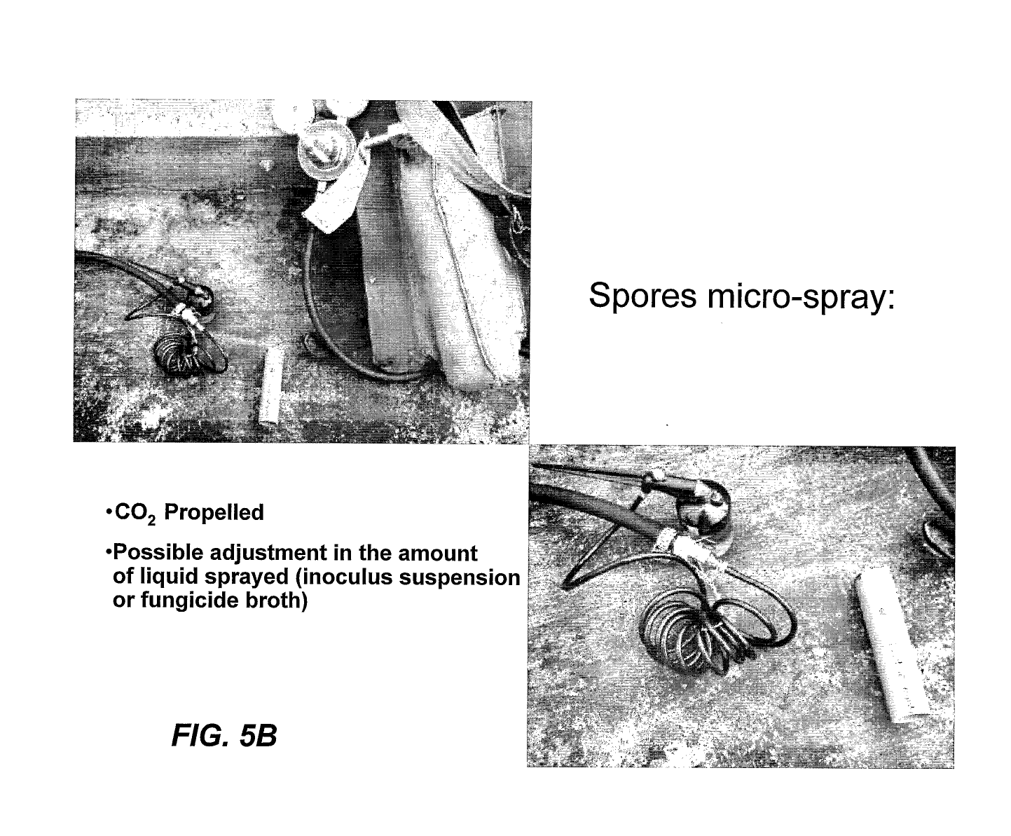

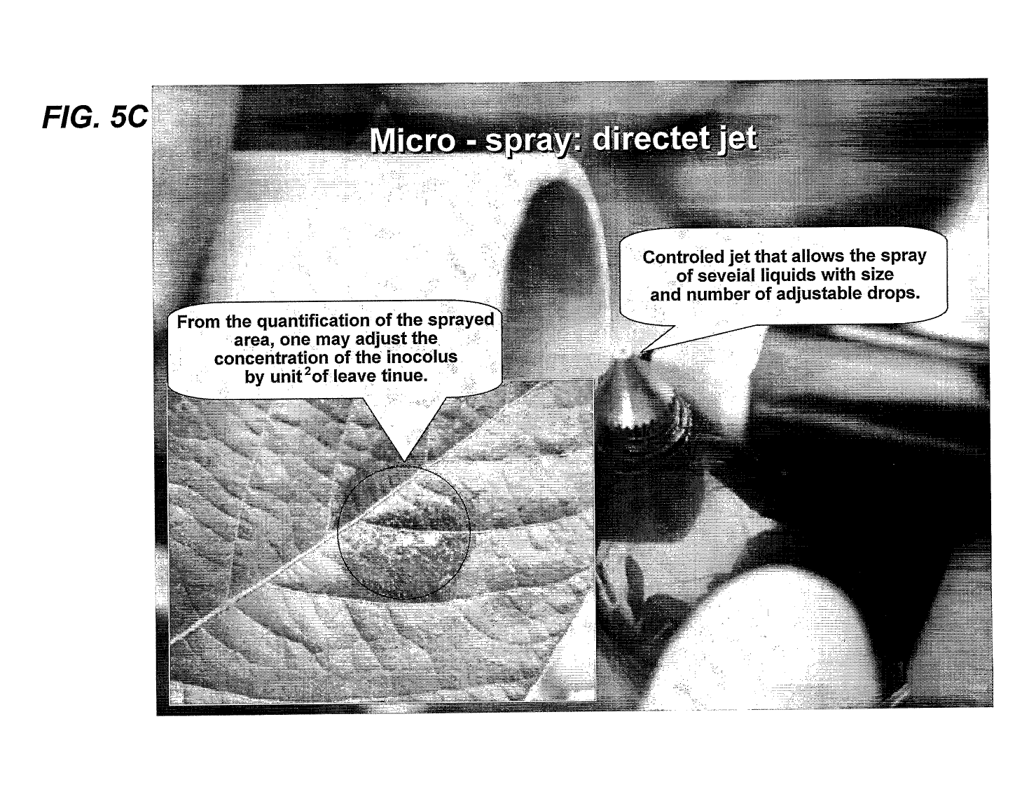

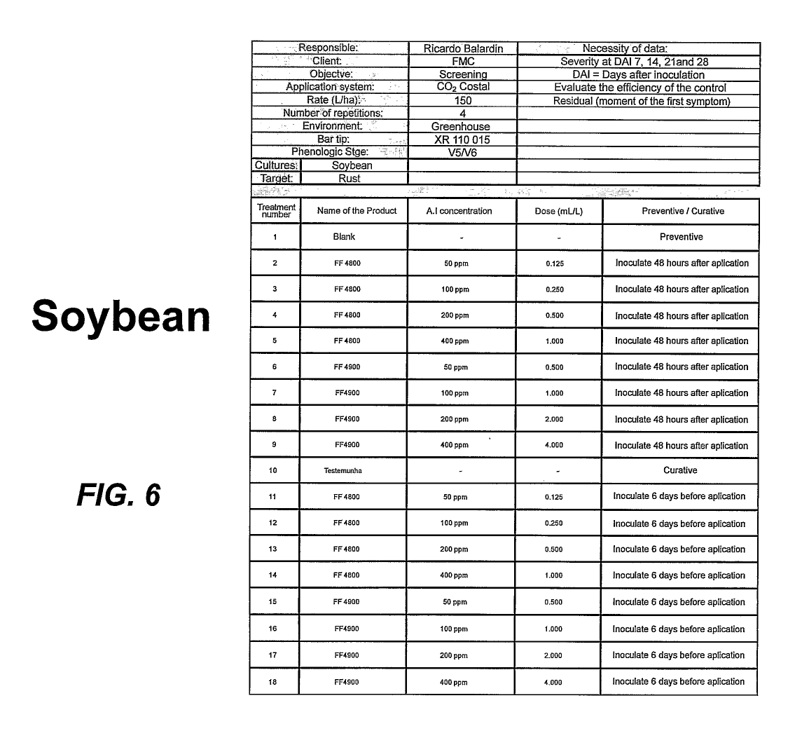

Tests in vitro in greenhouse (see FIGS. 5A and 5C):

Collecting the uredospores directly from the infected leaves (see FIG. 5A);

Microspraying spores (see FIG. 5B);
CO₂ propelled;
Possibility of adjusting the amount of sprayed liquid (suspension of inoculus and fungicide broth)

Microsprayer: directed jet (see FIG. 5C)

Tests in vivo:

Action is spores;

Preventive/curative action;

Methodology.

Preparing the solution

Dissolution:
FF4800

Weighted (0.1205 g);

Dissolved in 20 mL of pure methanol;

Dilluted in 80 mL of distilled water;

Stock solution in the concentration of 1000 ppm.
FF4900

Weighted (0.1205 g);

Dissolved in 20 mL of pure methanol;

Dilluted in 80 mL of distilled water;

Stock solution in the concentration of 1000 ppm.
FF4901

Weighted (0.4545 g);

Dissolved in 40 mL of a 50% acetic acid/50% distilled water solution, plus 20 mL of pure methanol;

Dilluted in 40 mL of distilled water, with the aid of ultrasound (15 min);

Stock solution in the concentration of 1000 ppm.

Inhibition Index

Relationship between the fungi growing area in the solvent alone, blank (agar) and product+solvent;

The higher the inhibition index, the higher the efficiency of the product.

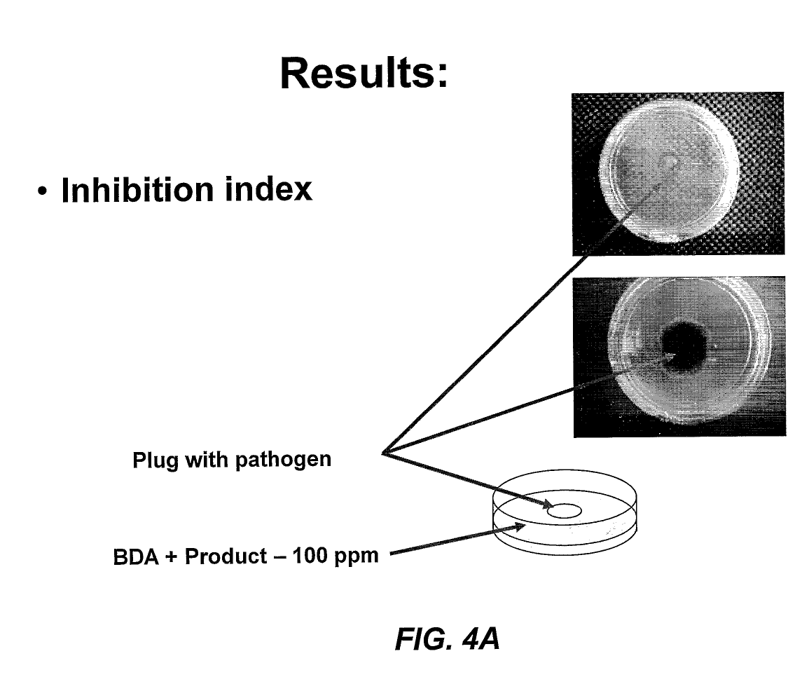

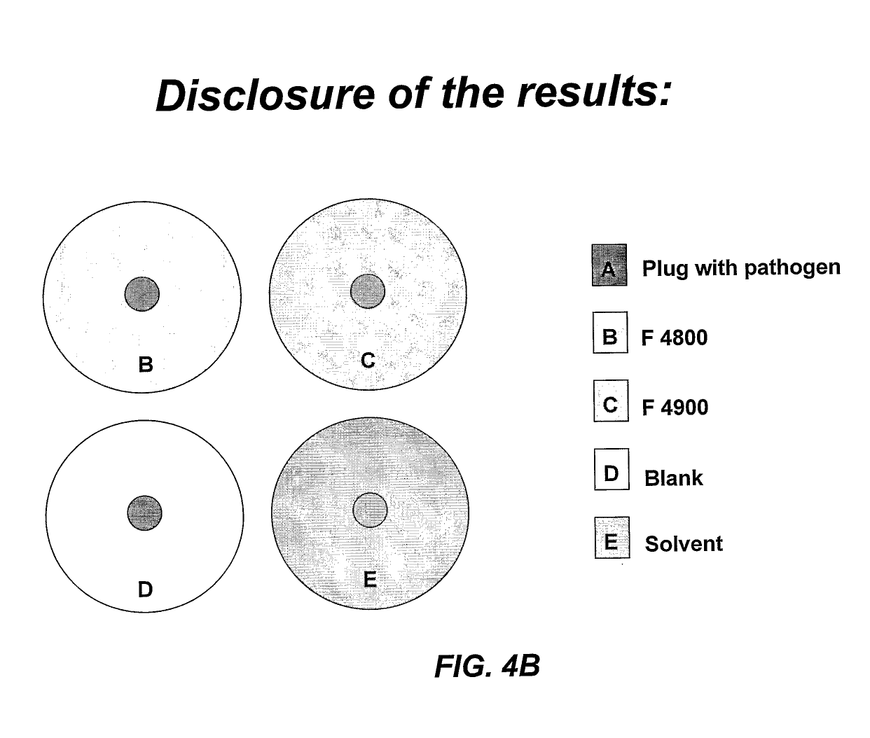

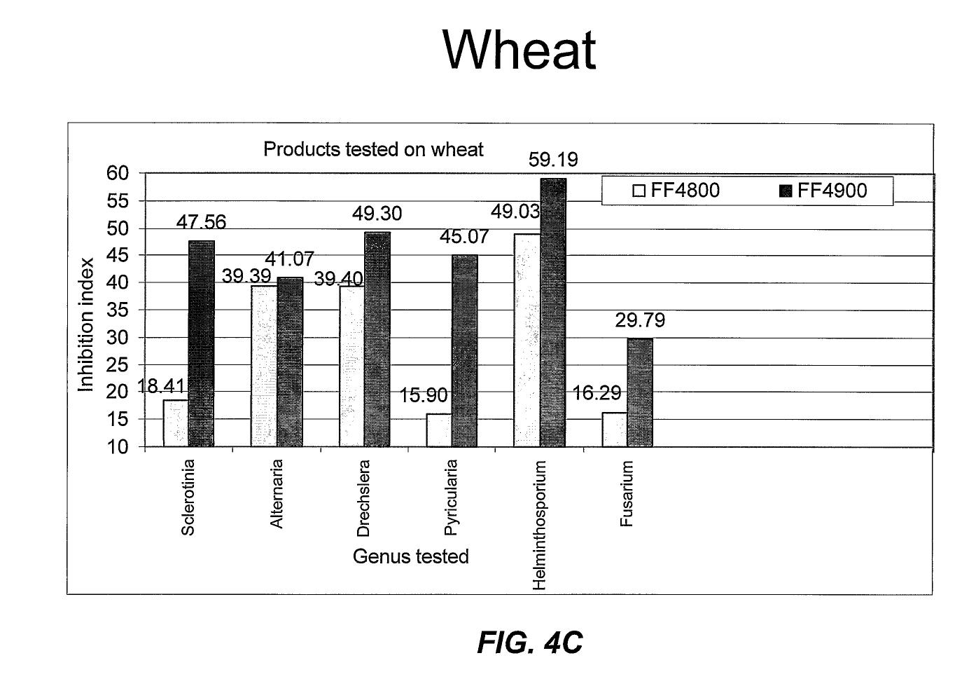

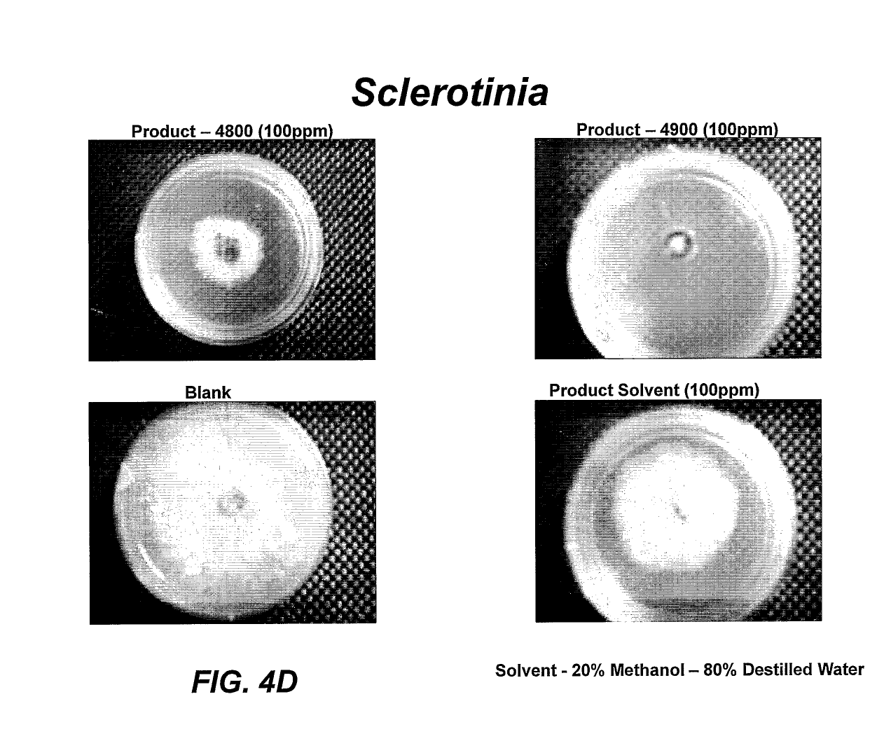

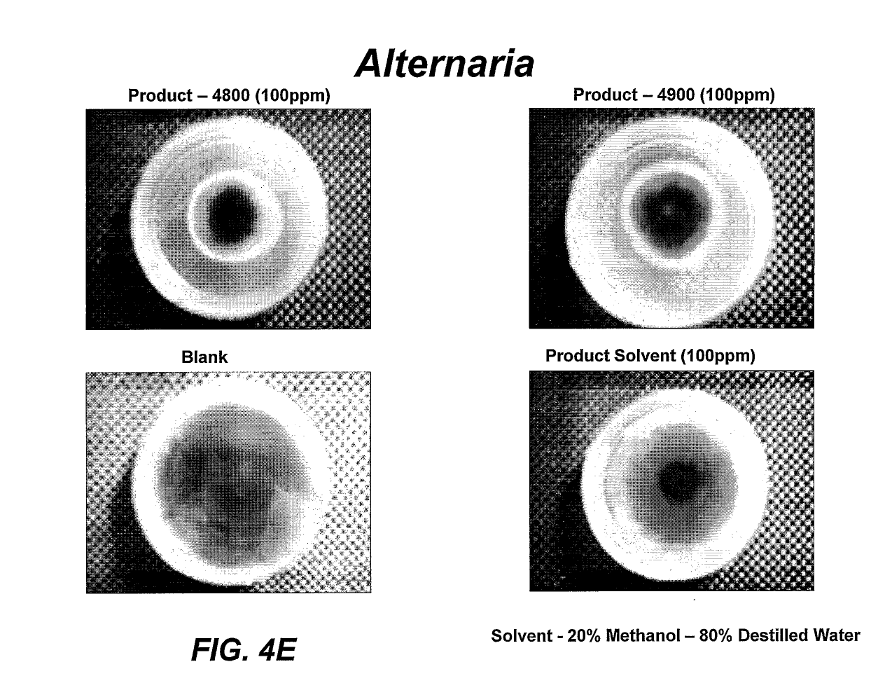

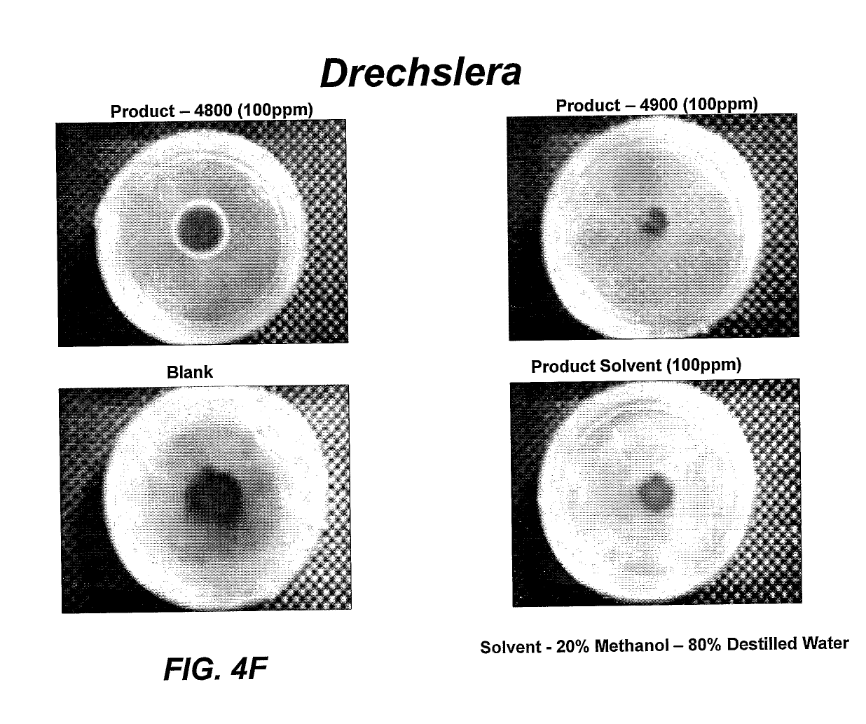

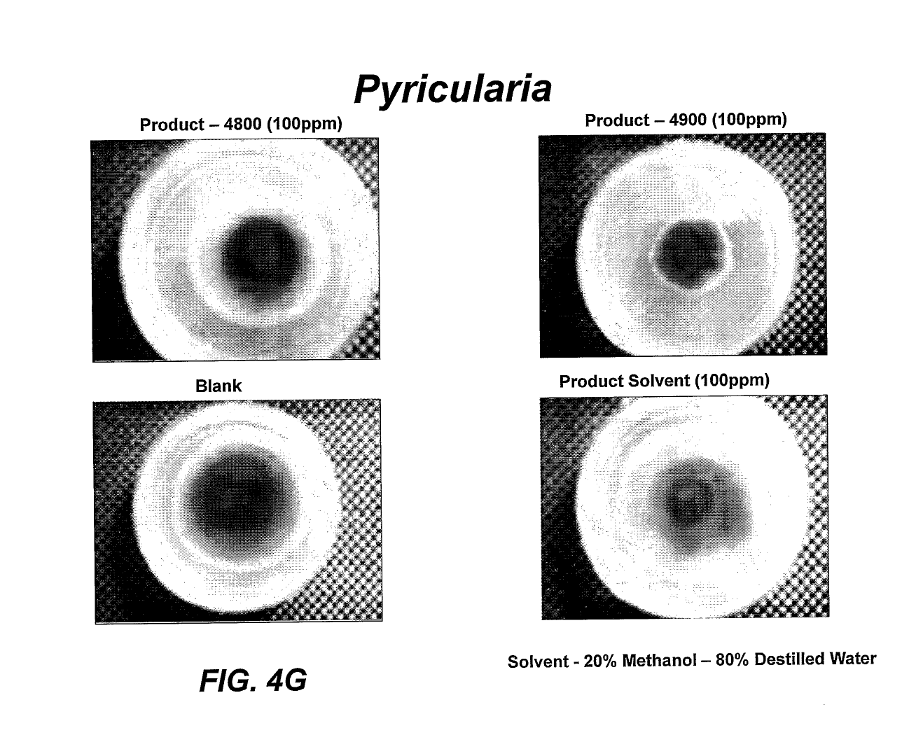

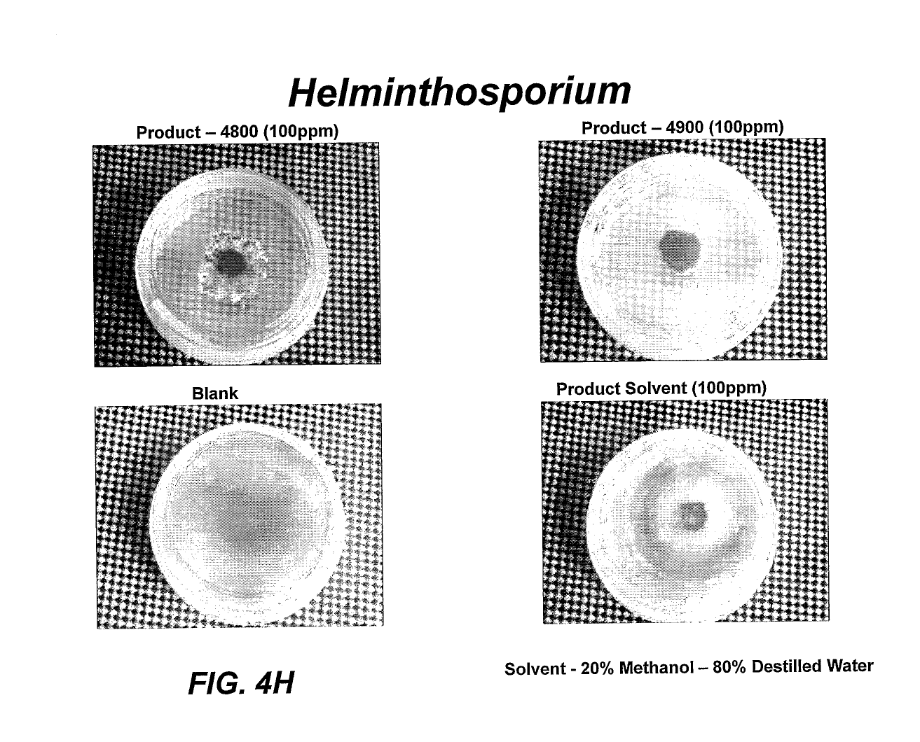

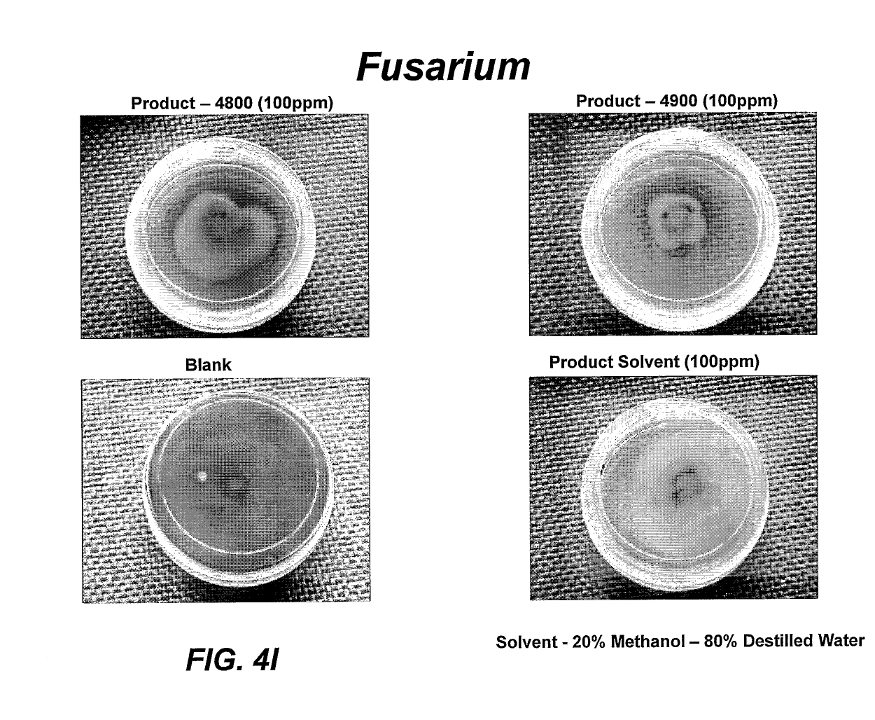

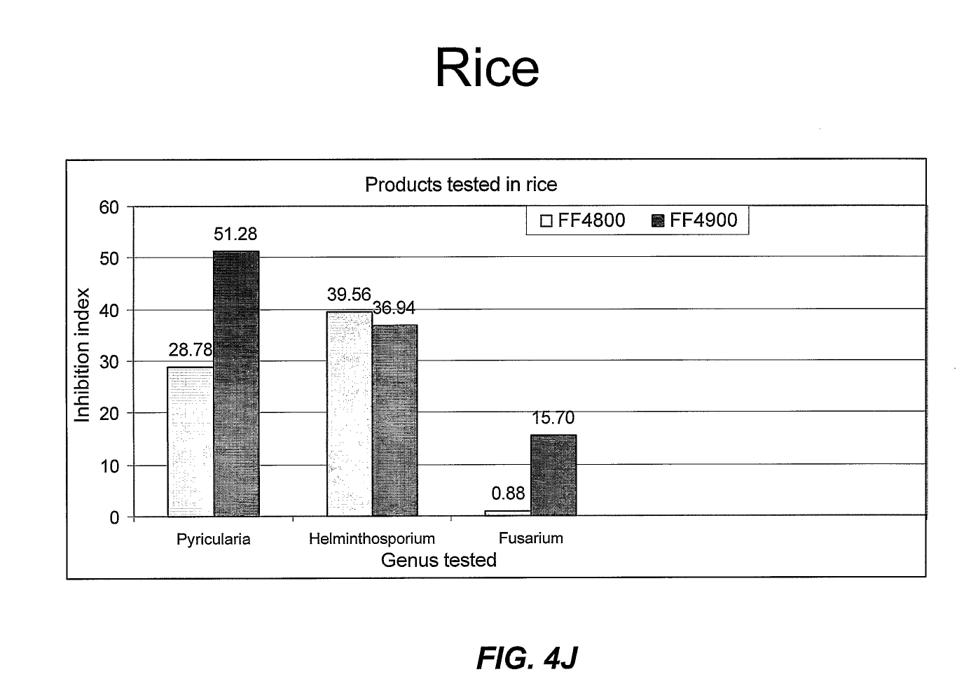

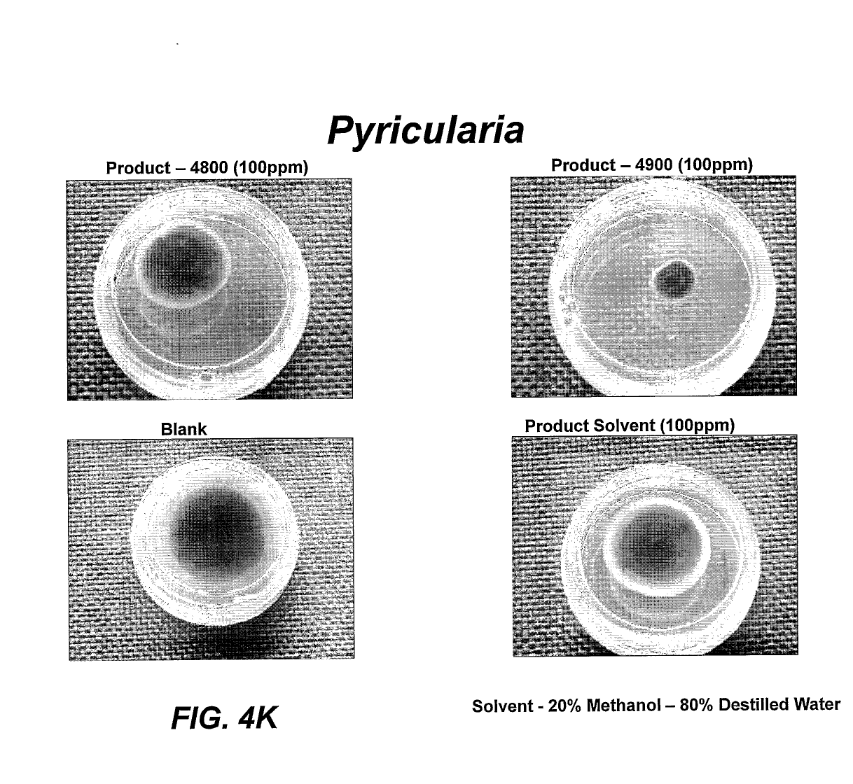

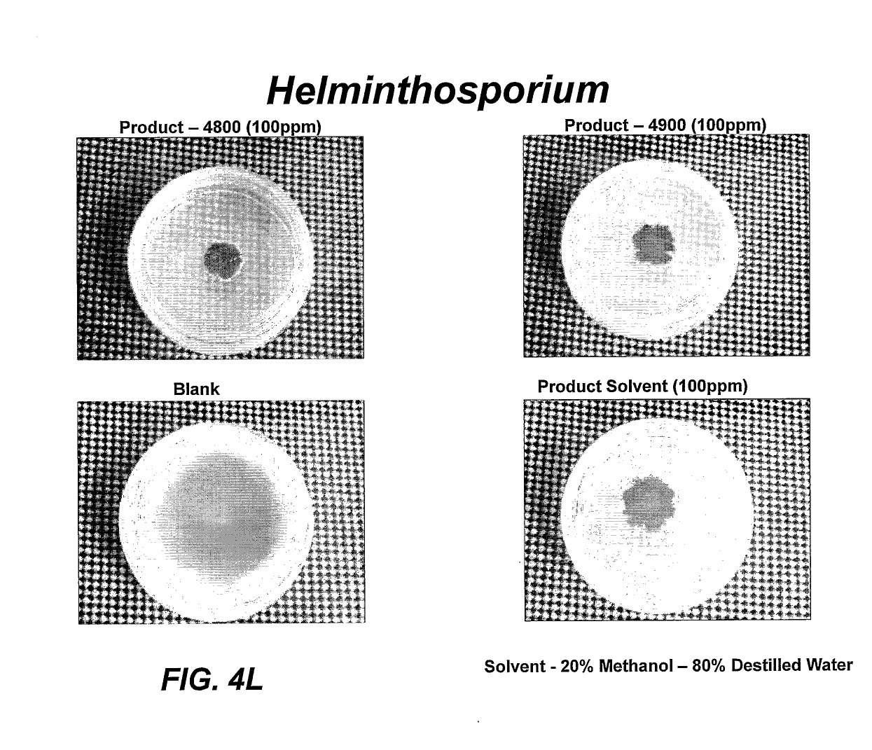

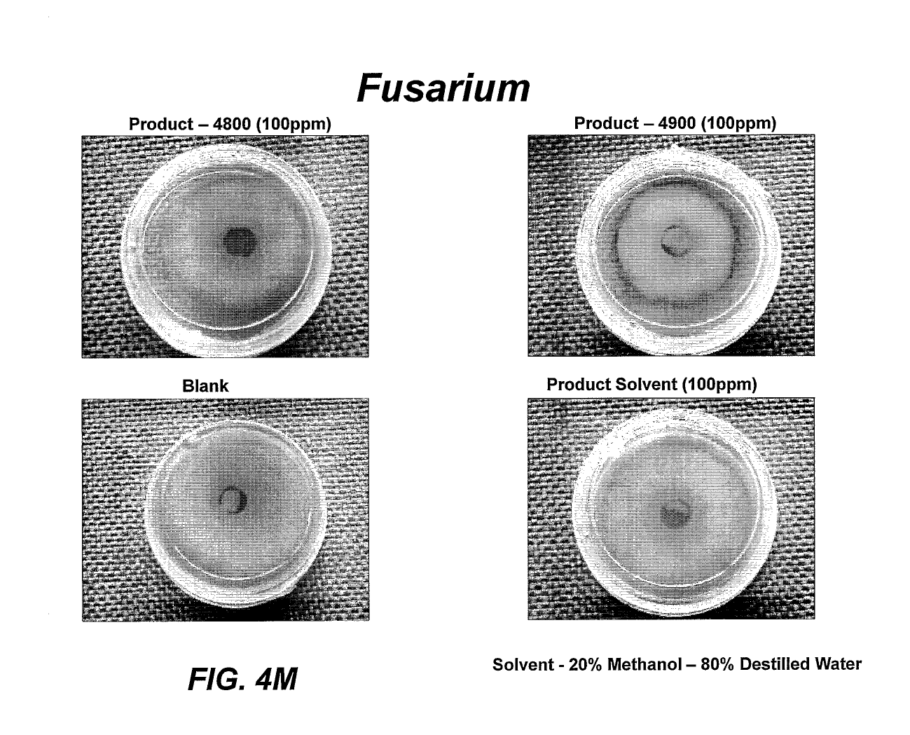

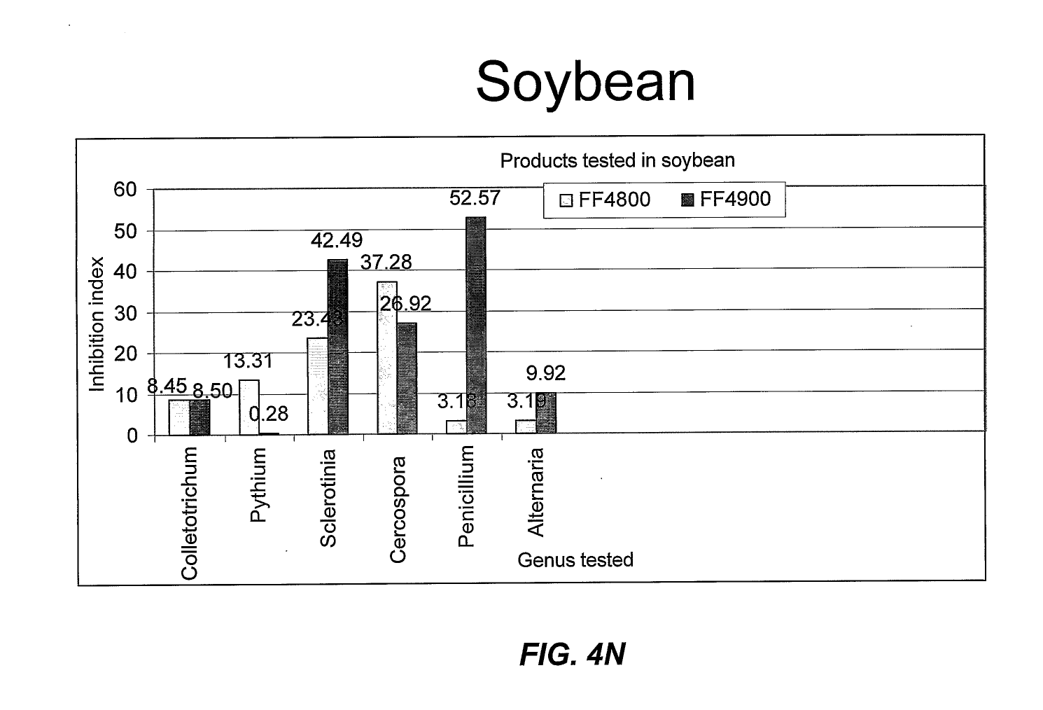

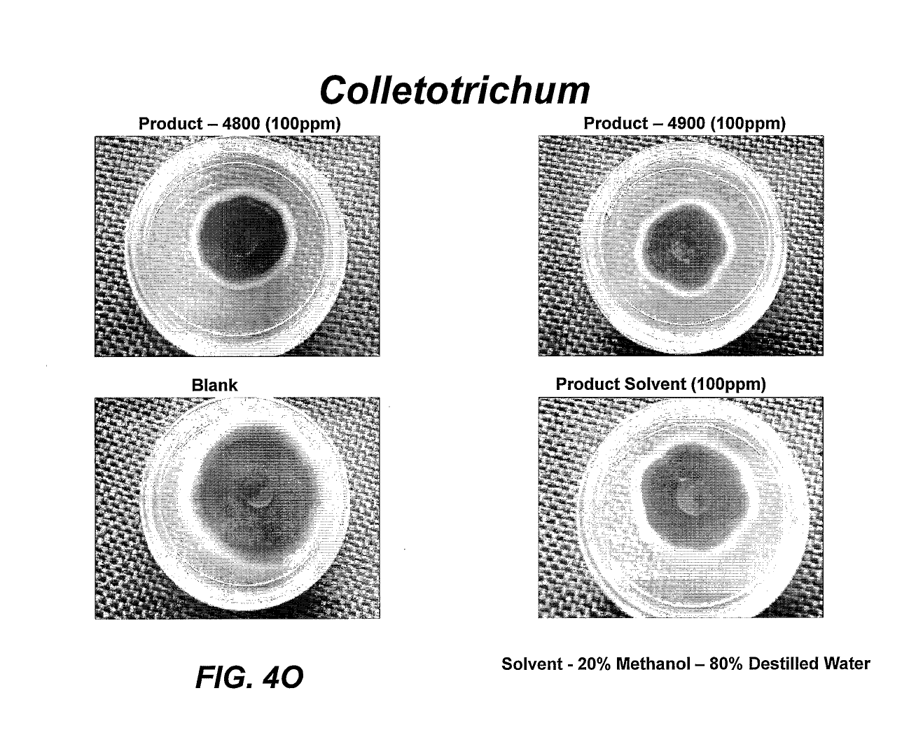

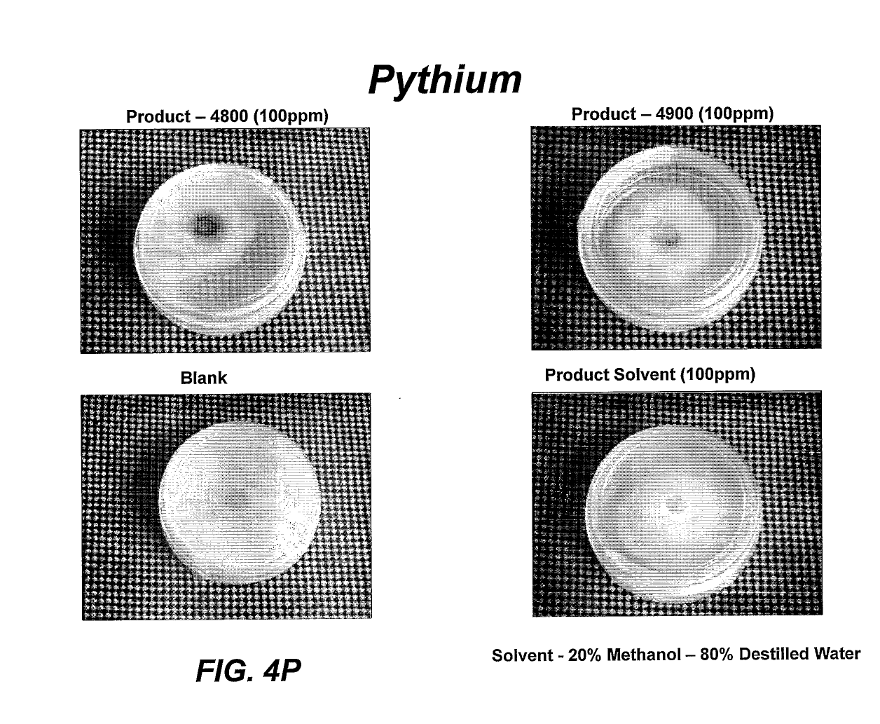

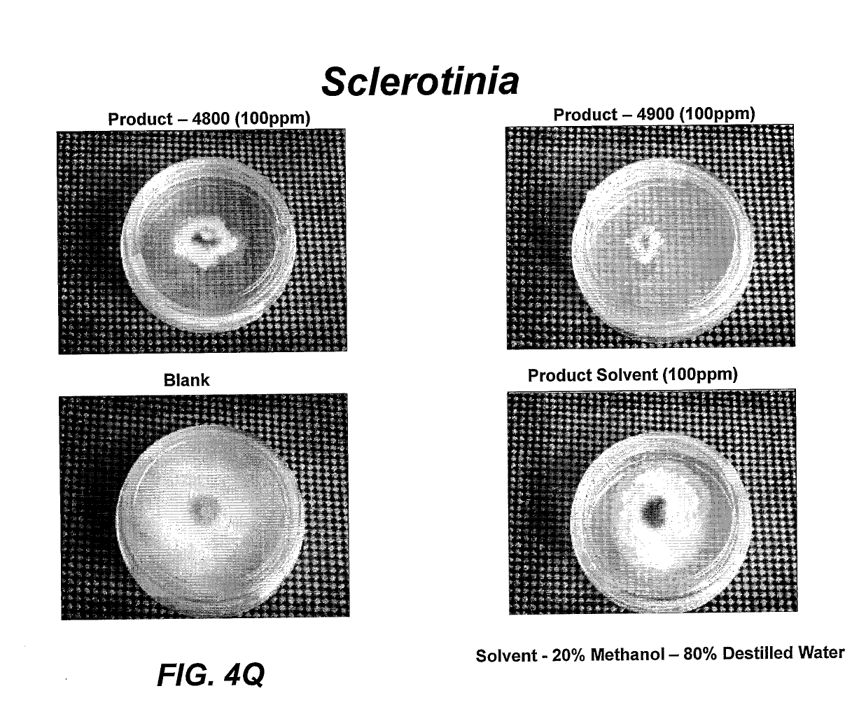

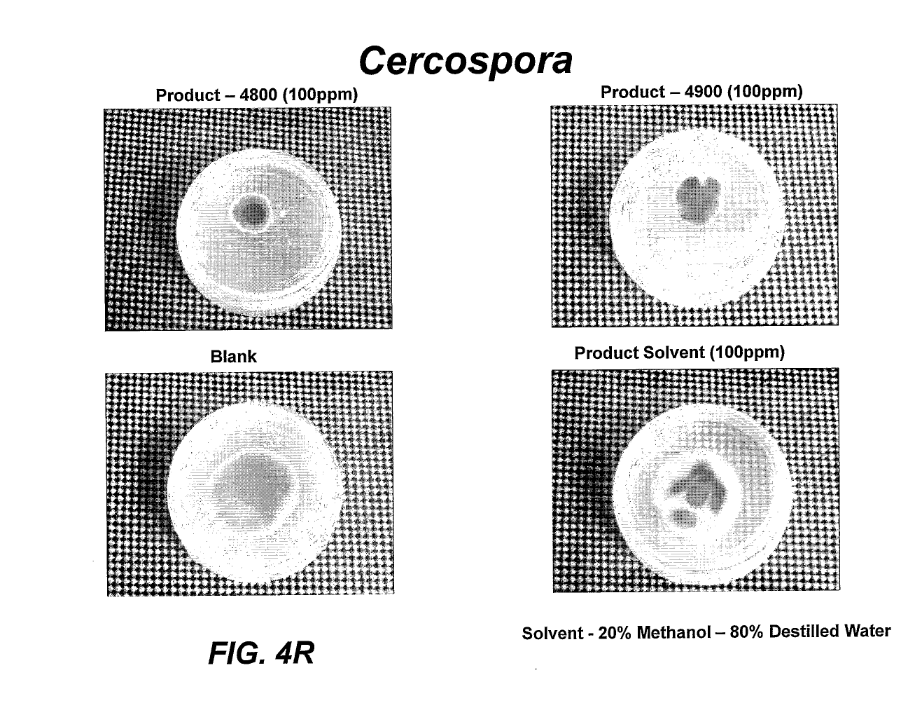

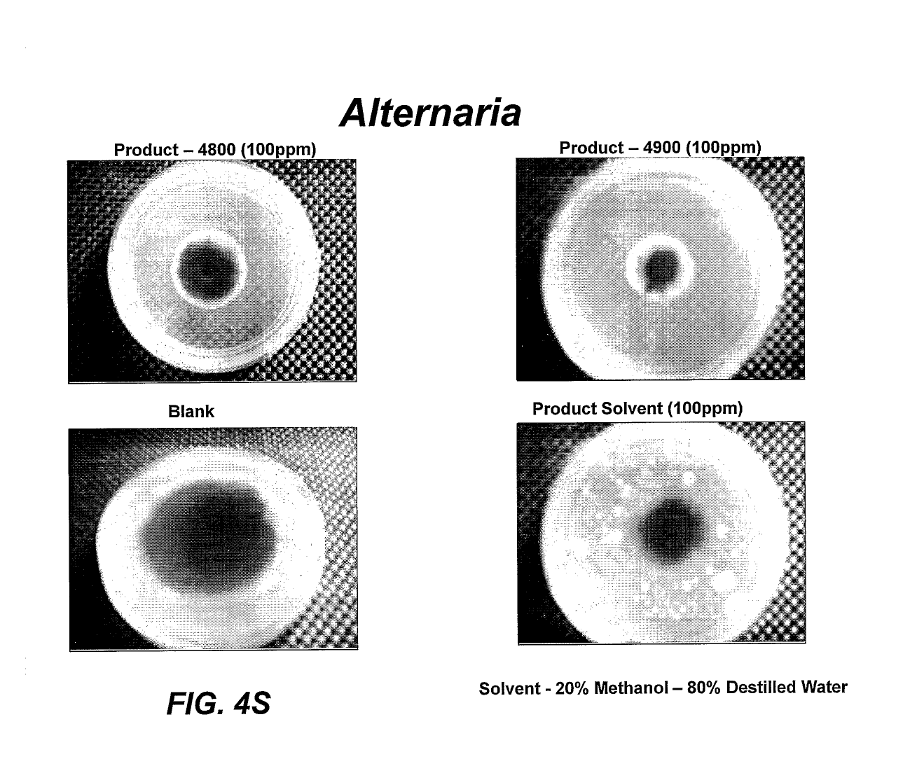

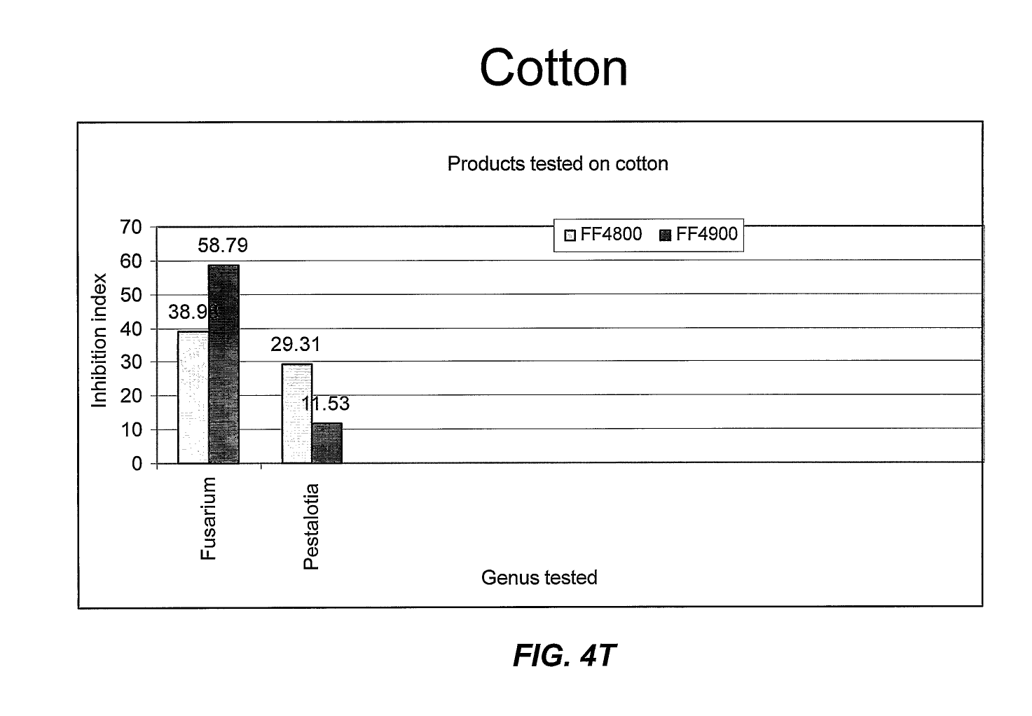

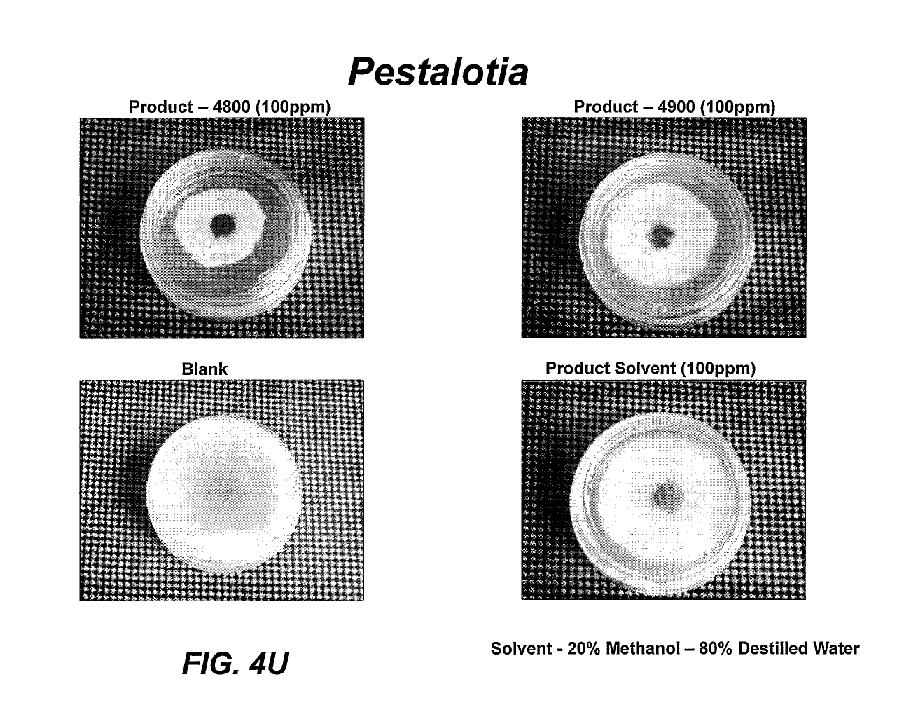

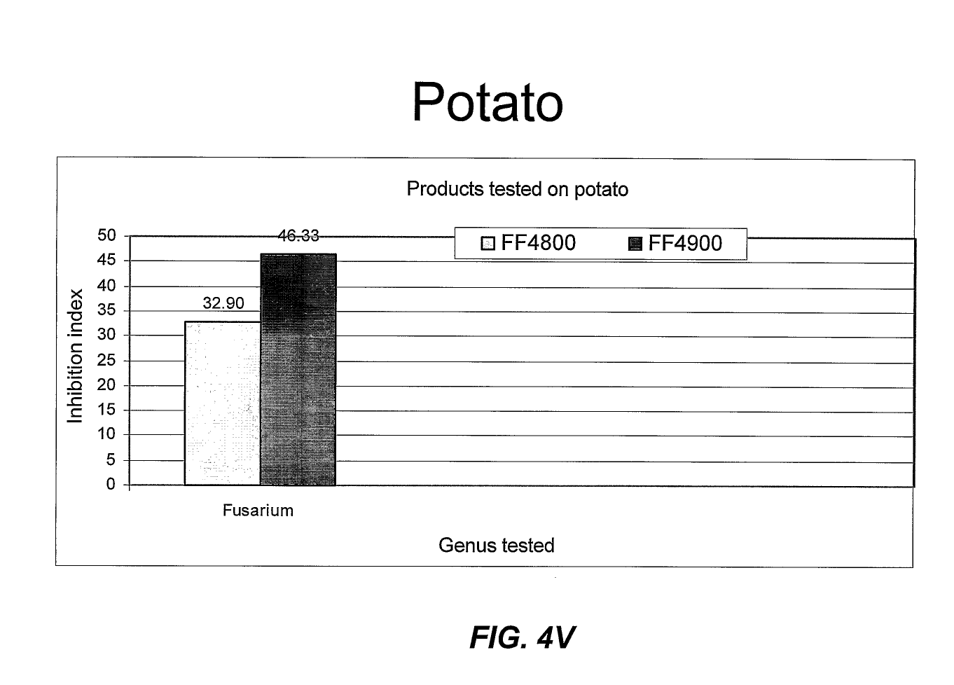

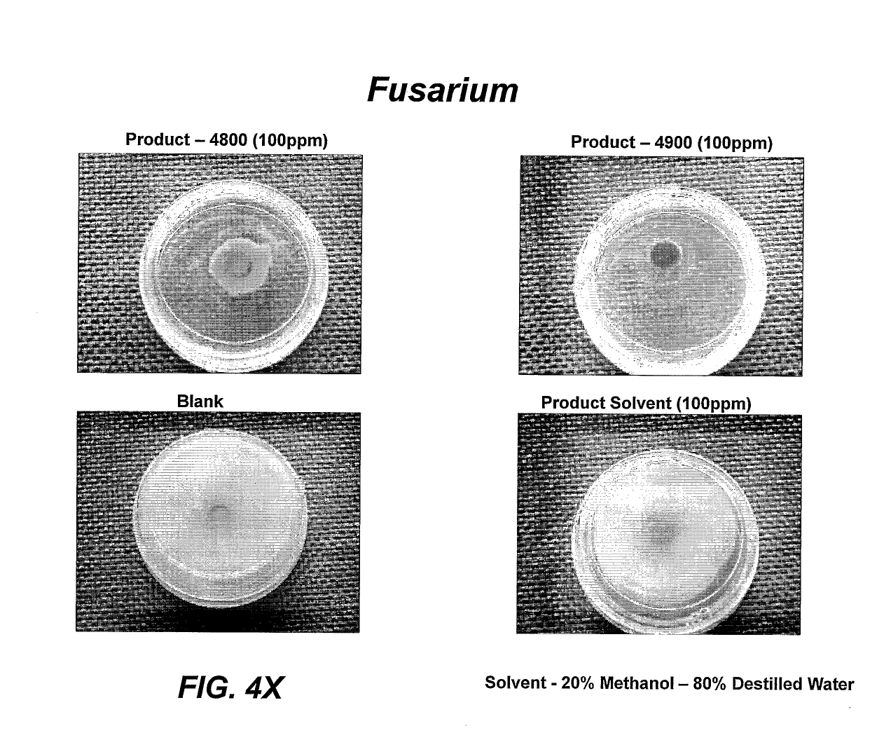

The inhibition index results are shown in FIGS. 4A to 4X.
Results of the 2^{nd} step with defined crops (Evaluation of efficiency of fungicides for controlling soybean asian rust caused by Phakopsora pachyrhizi in the State of Mato Grosso, Brazil)

### Materials and Methods

Several fungicides were evaluated in the control of soybean asian rust (Table 1A). The experiment was effected in Rondonópolis, MT, Brazil, harvest 2005/06, in a commercial area with soybean cultivar. The experiment consisted of 13 treatments (Table 1A).

TABLE 1A
Characterization of the evaluated fungicides and doses in the
control of the soybean asian rust, Rondonópolis, MT, Brazil.

| Treatments | | Dose | |
|---|---|---|---|
| Trade Name | Common Name | i.a g ha⁻¹ | P.C. mL ha⁻¹ |
| Domark + Derosal | Tetraconazole + | 50 + 250 | 500 + 500 |
| | Carbendazin | | |
| Domark + Derosal | Tetraconazole + | 40 + 200 | 400 + 400 |
| | Carbendazin | | |
| Domark | Tetraconazole | 50 | 500 |
| Elite + Derosal | Tebuconazole + | 100 + 250 | 500 + 500 |
| | Carbendazin | | |
| Elite | Tebuconazole | 100 | 500 |
| Opera | Pyraclostrobin + | 66.5 + 25 | 500 |
| | Epoxiconazole | | |
| PrioriXtra | Azoxystrobin + | 60 + 24 | 300 |
| | Cyproconazole | | |
| Impact | Flutriafol | 62.5 | 500 |
| FF-4900 | — | — | 500 |
| FF-4900 | — | — | 750 |
| FF-4900 | — | — | 1000 |
| FF-4800 | — | — | 1000 |
| Blank | — | — | — |

The experimental outlining was random, in blocks, with 13 treatments and 4 repetitions. Each plot consisted of 6 lines of 6 m, spaced 0.45 m.

The culture traits were suited to the good development of the soybean crop, uniformly applied in the whole experiment.

The spraying was effected in stadiums R3 and R5.1, with coast CO₂ sprayer provided with a JA-02-type beak, under a pressure of 0.31 MPa (45 psi), using 110 L of broth per ha. At the first application, the plants were presenting the beginning of rust symptoms at their foliar areas.

The rust was evaluated by analysing the percentage of foliar area affected by the disease, according to Godoy et al., in the plants of the three central lines. Evaluationa related to soybean injury and severity were effected in 14 and 21 days after the first application (DDA), by means of visual observation of the leaves of the plot plants.

### Results

The results are shown in Table 2A.

TABLE 2A
Effect of fungicides, evaluated in 14 and 21 days after the first
application, on the severity caused by the soybean rust
(Phakopsora pachyrhizi), Rondonópolis, MT, Brazil.

| | | Severity - affected foliar | |
|---|---|---|---|
| Treatments | | area (%) | |
| Trade Name | Dose (P.C. mL ha⁻¹) | 14 DAA | 21 DAA |
| Domark + Derosal | 500 + 500 | 0.3 | 0.9 |
| Domark + Derosal | 400 + 400 | 0.4 | 1.5 |
| Domark | 500 | 0.3 | 1.0 |
| Elite + Derosal | 500 + 500 | 0.3 | 0.9 |
| Elite | 500 | 0.3 | 0.9 |
| Opera | 500 | 0.5 | 2.0 |
| PrioriXtra | 300 | 0.6 | 2.0 |
| Impact | 500 | 0.3 | 1.1 |
| FF-4900 | 500 | 0.6 | 4.0 |
| FF-4900 | 750 | 0.5 | 2.0 |
| FF-4900 | 1000 | 0.4 | 1.5 |
| FF-4800 | 1000 | 2.0 | 7.0 |
| Blank | — | 8.3 | 19.2 |

Examples of embodiment having been described, it should be understood that the present invention embraces other configurations, being limited only by the scope of the accompanying claims.

1. A use of an agrochemically effective amount of fluconazole, characterized by being for the treatment of seeds, foliar diseases and/or soils against attacks by pests on plants.

2. A use of an agrochemical amount of fluconazole, characterized by being for the preparation of a fungicide/insecticide/herbicide/nematocide usable in the treatment of seeds, foliar diseases and/or soils against attack by pests on plants.

3. The use according to claim 1, characterized in that the agrochemically effective amount of fluconazole comprises from 50 to 500 grams of active ingredient per liter or kilogram of the formulated product.

4. The use according to claim 1, characterized in that the pest to be attacked is Phakopsora pachyrhizi.

5. The use according to claim 1, characterized in that the plant to be treated is selected from soybeans and transgenic soybeans.

6. A method of controlling diseases/insects/mites/nematodes and weeds, particularly foliar diseases and/or diseases of the soil, characterized by comprising the application to the place to be protected or to the insect itself of an agrochemically effective amount of fluconazole.

7. The method according to claim 6, characterized by utilizing the following proportions of active compound for each specific treatment:
(a) For the treatment of seeds: from 5 to 500 grams of the active compound(s) per 100 kg of seeds;
(b) For the treatment of leaves, each crop requires a specific dose of the active compound(s), from 20 to 500 grams of the active compound(s) per hectare;
(c) For use in the soil, from 100 to 500 grams of active compound(s) per hectare.

8. The method according to claim 6, characterized in that the pest to be attacked is Phakopsora pachyrhizi.

9. The method according to claim 6, characterized in that the plant to be treated is selected from soybeans and transgenic soybeans.

10. The use according to claim 2, characterized in that the agrochemically effective amount of fluconazole comprises from 50 to 500 grams of active ingredient per liter or kilogram of the formulated product.

11. The use according to claim 2, characterized in that the pest to be attacked is Phakopsora pachyrhizi.

12. The use according to claim 2, characterized in that the plant to be treated is selected from soybeans and transgenic soybeans.

13. The method according to claim 7, characterized in that the plant to be treated is selected from soybeans and transgenic soybeans.

14. The method according to claim 8, characterized in that the plant to be treated is selected from soybeans and transgenic soybeans.
